(19) United States
(12) Patent Application Publication
(10) Pub. No.: US 2013/0311470 A1
(43) Pub. Date: Nov. 21, 2013

(54) AUTOMATIC CLASSIFICATION OF INTERPERSONAL RELATIONSHIP BASED ON SOCIAL NETWORKING ACTIVITIES

(71) Applicant: Mohsen Lotfi, Hamburg (DE)

(72) Inventor: Mohsen Lotfi, Hamburg (DE)

(21) Appl. No.: 13/897,368

(22) Filed: May 18, 2013

Related U.S. Application Data
(60) Provisional application No. 61/637,685, filed on May 21, 2012.

(51) Int. Cl. G06F 17/30

(52) U.S. Cl. CPC G06F 17/30705
USPC 707/737

(57) ABSTRACT

Provided are methods and systems for automatic categorizing of interpersonal relationships of a user of a social networking service with the contacts of the user in the social networking service. The monitoring of relationships of a user is performed by integration within the social networking service to receive communication data of the user. The communication data is pre-analyzed using a user predefined configuration, and then analyzed according to timing and content factors. The timing and content factors include a frequency, a date, a time, an intensity, and content of communication of the user and the contacts of the user. Based on the analyzing, the interpersonal relationships of the user and contacts of the user is categorized and optionally stored and provided to the user via a graphical output interface.

### CROSS-REFERENCE TO RELATED APPLICATIONS

This application claims priority of U.S. Provisional Application No. 61/637,685, entitled “AUTOMATIC CLASSIFICATION OF INTERPERSONAL RELATIONSHIP BASED ON SOCIAL NETWORK ACTIVITIES,” filed May 21, 2012, which is incorporated herein by reference in its entirety for all purposes.

### FIELD

This application relates generally to data processing, and more specifically to automatic categorizing of interpersonal relationships of social networking users.

### BACKGROUND

The Internet has changed the way people communicate, find and share information, learn, build and maintain their relationships and perform other everyday activities. Internet companies try to develop tools that emulate the way people interact with each other in real life. Development of Internet technologies has resulted in proliferation of social networking. The number of social network users has drastically increased in recent years, and this number continues to grow.

As greater numbers of people communicate through social networks, share personal information, media files, media applications, pictures, videos, audio, and so on online, the lack of real face-to-face communication may entail problems of emotional involvement and thus, create barriers to further improvement of relationships and to extension of social circles of the user.

Additionally, because users have different relationships with different social network contacts, they may need to categorize their contacts accordingly. Furthermore, there may be a need for developing and improving of the relationships with the existing contacts of the user.

Thus, there may be a need to understand, classify and categorize interpersonal relationships between the users of social networks. However, managing such categorizations manually may be time-consuming and tedious for users. For example, a user may need to periodically edit or change information concerning types and levels of his relationships with other users.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for automatic categorizing of interpersonal relationships of a user of a social networking service with contacts of the user in the social networking service. Interpersonal relationships of the user with his contacts in the social networking service may be categorized automatically based on various factors, such as frequency of communication, time, intensity, content, and so forth. Thus, time of the user may be saved, and the use of the social networking service may be simplified.

The monitoring of relationships of a user may be performed by integration of the system for automatic categorizing of interpersonal relationships as an add-on or a third party web application in the social networking service, or more specifically, in the profile of the user. The system may receive communication data concerning user activities and relationships, for example, adding a new post in the social networking service, updating of an existing post in the social networking service, responding to the existing post, reacting to the existing post, evaluating the existing post, sharing the existing post, and so forth.

Communication data received through monitoring of user activities may be pre-analyzed using a user predefined configuration to adjust value of the data according to user settings of the user predefined configuration. Based on the pre-analysis, the data may be analyzed according to timing and content factors. The timing and content factors may include frequency, date and time (e.g. holidays only or daily, and time of the day), intensity (e.g. several times a day, etc.) and/or content of communication between the monitored user and his contacts within a social networking service.

Based on the analysis, interpersonal relationships of the user may be categorized. The categorized interpersonal relationships may be provided to the user via a graphical output interface.

In some embodiments, categorized interpersonal relationships may be represented as one or more relationship circles.

Thus, the present disclosure provides a useful tool for automatic categorization of relationships in social networks and providing advice on their improvement and development.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a sample environment within which systems and methods for automatic categorizing of interpersonal relationships are implemented, according to an example embodiment.

FIG. 2 is a block diagram showing a sample system for automatic categorizing of interpersonal relationships, according to an example embodiment.

FIG. 3 is a flow chart illustrating a method for automatic categorizing interpersonal relationships, according to an example embodiment.

FIG. 4 is an example graphic representation of categorized interpersonal relationships of a user, according to an example embodiment.

FIG. 5 is a flow chart representing categorizing of interpersonal relationships of a user in a social networking service using a system for automatic categorizing of interpersonal relationships, according to an example embodiment.

FIG. 6 represents detailed analyzing of communication data of a user of a social networking service via a system for automatic categorizing of interpersonal relationships, according to an example embodiment.

FIG. 7 is a diagrammatic representation of an example machine in the form of a computer system within which a set of instructions for causing the machine to perform any one or more of the methodologies discussed herein is executed.

### DETAILED DESCRIPTION

Systems and methods described herein may allow providing users of such services as a social networking website, a microblog, a blog, a forum and so forth with a mechanism for monitoring and automatic categorizing of interpersonal relationships of a user of a social networking service with contacts of the user in the social networking service. This may be realized by automatic processing of communication data of the user related to various activities of the user in the social networking service.

In one example embodiment, the methods disclosed herein may involve automated collecting of data associated with user profiles and activity of the users of social networks and further processing, analyzing and categorization of the data. The operations associated with collecting, processing and providing the results of the data analysis to the users may be performed automatically by a system for automatic categorizing of interpersonal relationships. The system for automatic categorizing of interpersonal relationships may comprise an add-on or a third-party application integrated in a social networking service.

In various example embodiments, the data collected from the user profile may include data concerning user activities, for example, frequency, date and time (e.g. only holidays or regularly, and time of day), intensity (e.g. several times a day), or content of contacts between the user and his contacts in the social networking service.

The collected data may be analyzed, processed, and categorized based on various algorithms; the results of categorization may then be provided to the user of the social networking service, whose activities data were processed. The categorization data may be provided via a graphical output interface or by any other way convenient for the user.

The results of data categorization may be presented to the user as a graphical representation. For example, results of data categorization may be presented as a number of concentric circles wherein the central circle may represent the user and the circles surrounding the central circle may represent contacts of the user in the social network according to the kind of relationships between the user and the contacts. Accordingly, the closer is the relationships between a contact and the user; the closer will be the location of the contact to the central circle.

In another example embodiment, the system for automatic categorizing of interpersonal relationships may provide the user with an advice on ways of improving relationships with specific contacts using various functionalities and utilities.

For purposes of this document, a social networking service is defined as any online tool that allows users to establish connections and “online relationships” and share information in a restricted manner defined by these connections and relationships. For example, a user may define a group of trusted contacts, ignore contacts, and/or set thresholds for contacts to join groups and other communication channels. Some existing examples of social network services include Facebook, Friendster, Twitter, and other similar services. However, one having ordinary skills in the art would understand that social networking services are not limited to these examples. Social network services may include standalone systems or be built as add-ons to existing online environments. Other examples of social networking services may include micro-blogging websites and online media sources.

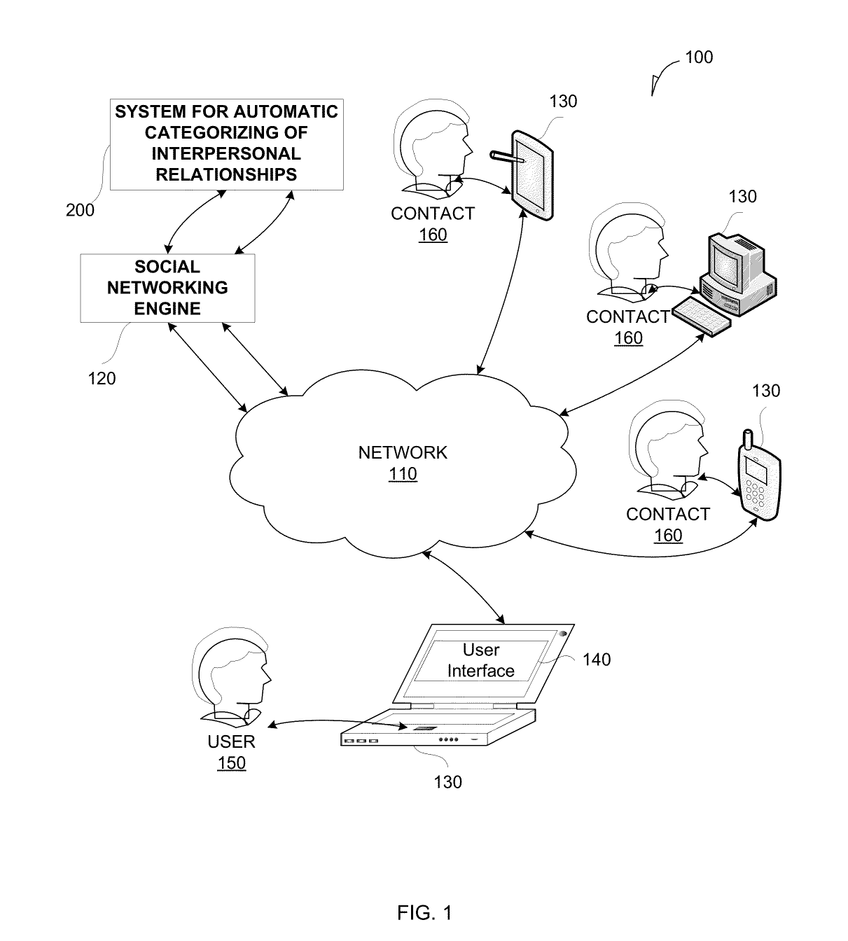

FIG. 1 shows a sample environment 100 within which systems and methods for automatic categorizing of interpersonal relationships are implemented, according to an example embodiment. The environment 100 may include a network 110, a social networking service 120, one or more client devices 130, a user interface 140, a user 150, one or more contacts 160, and a system 200 for automatic categorizing of interpersonal relationships. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

The user 150 may represent the owner of the profile, from which the data for further categorization is to be collected. One or more contacts 160 may represent the participants of the same social networking service 120 interacting through the network 110 by means of various communicative devices 130. The user 150 may communicate with contacts 160 or share information or participate with them in different activities using the social networking service 120 facilitated by the network 110. The system 200 for automatic categorizing of interpersonal relationships may comprise an add-on or a third party application adapted to the social networking service 120 and serve for collecting, processing, and categorizing data associated with the activities of the user 150.

The client devices 130, in some example embodiments, may include a Graphical User Interface (GUI) for displaying the user interface 140. In a typical GUI, instead of offering only text menus or requiring typed commands, the system 200 may present graphical icons, visual indicators, or special graphical elements called widgets that may be utilized to allow the user 150 to interact with the contacts 160. The client devices 130 may be configured to utilize icons used in conjunction with text, labels, or text navigation to fully represent the information and actions available to user 150 and/or contacts 160.

The client devices 130 may include a mobile telephone, a computer, a lap top, a smart phone, a tablet PC, a personal digital assistant (PDA), and so forth. The user 150, in some example embodiments, may be a person interacting with the user interface 140 via one of the client devices 130. The user 150 may be a member of a social networking service 120. The user 150 may periodically interact with the social networking service 120 and provide information to the social networking service 120. This information may be stored and, in certain embodiments, analyzed by the social networking service 120 to create user specific information, such as user profile. This information may include various demographic information about the user 150 (e.g., age, gender, location), interests and preferences of the user 150, or connections of the user 150 in the social network (e.g., friends) and other types of information.

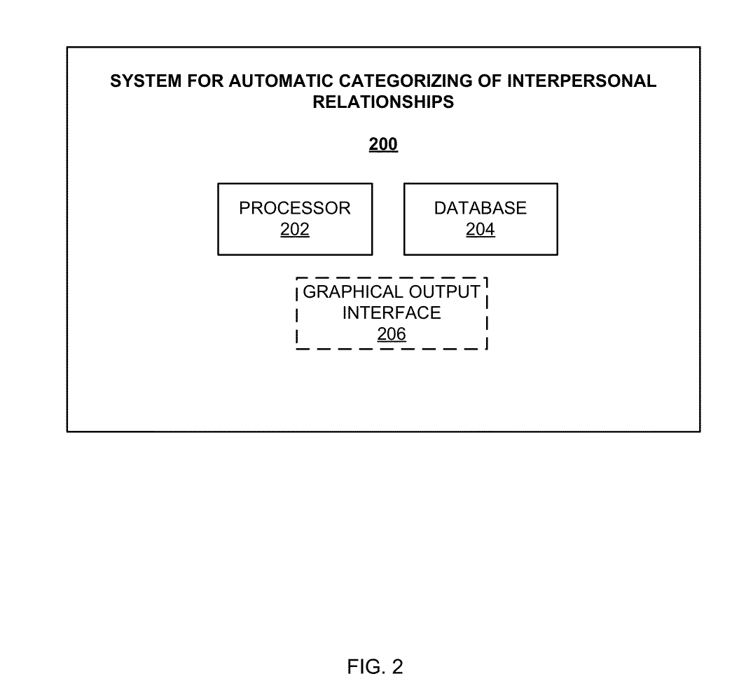

FIG. 2 shows a detailed block diagram of the system for automatic categorizing of interpersonal relationships 200, in accordance with an example embodiment. The system 200 may include a processor 202, a database 204, and, optionally, a graphical output interface 206.

The processor 202 may be configured to integrate in a social networking service to provide connection to the user profile in the social networking service and retrieve data associated with the user. This data may include data concerning user activities, such as frequency, date and time, intensity, and content of communication between the user and his contacts in the social networking service. The communication data may be received by the processor 202 and stored in the database 204. The communication data may be pre-analyzed using a user predefined configuration. The user predefined configuration may be a stand-alone or integrated module for user administration and supervision processes. This module may provide user with necessary tools to administrate and supervise analyzing and categorizing process. Main functionality of this module may include authentication permissions (to allow communication of the system 200 with the social networking service and to provide the user with tools to manually assist or override the analyzing process.

When communication data of the user is received, the processor 202 may pre-analyze the communication data based on the user settings in the user predefined configuration. Thus, the processor may check if the user settings associated with the contact the communication data is related to exist. If so, the communication data value may be adjusted based on the user settings. Additionally, pre-analyzing may include adjustments based on past analysis of the interpersonal relationships between the user and the contact. If any information related to the past analysis is found, this information may be considered in the analyzing process.

Then, the processor 202 may analyze the communication data according to timing and content factors. The analysis may consider adjustments and information from the pre-analyzing process. The timing and content factors may include frequency, date, time, intensity, content, and other factors of communication of the user and the one or more contacts. To evaluate the timing and content factors, the processor may extract a section of the communication data related to the factors (for example, date, time, symbols, and so forth).

During the analyzing process, an interpersonal relationship value associated with the contact may be calculated and saved to the database 204.

The processor 202 may then automatically process and categorize the interpersonal relationship of the user and the contact related to the communication data based on the interpersonal relationship value. For example, a category of interpersonal relationship associated with the interpersonal relationship value may be determined and assigned to the contact.

The data of the categorization may be provided to the user via a graphical output interface 206 communicating with the networking service. Additionally, the data of the categorization may be provided to the user by other means.

The data of the categorization may help the user to understand the current stage and the trend of his relationship with his contacts. In some embodiments, the system 200 may provide advice to the user on developing, improving, and enhancing of his relationships with one or more contacts. The trend and/or advice may be provided with the graphical output interface 206.

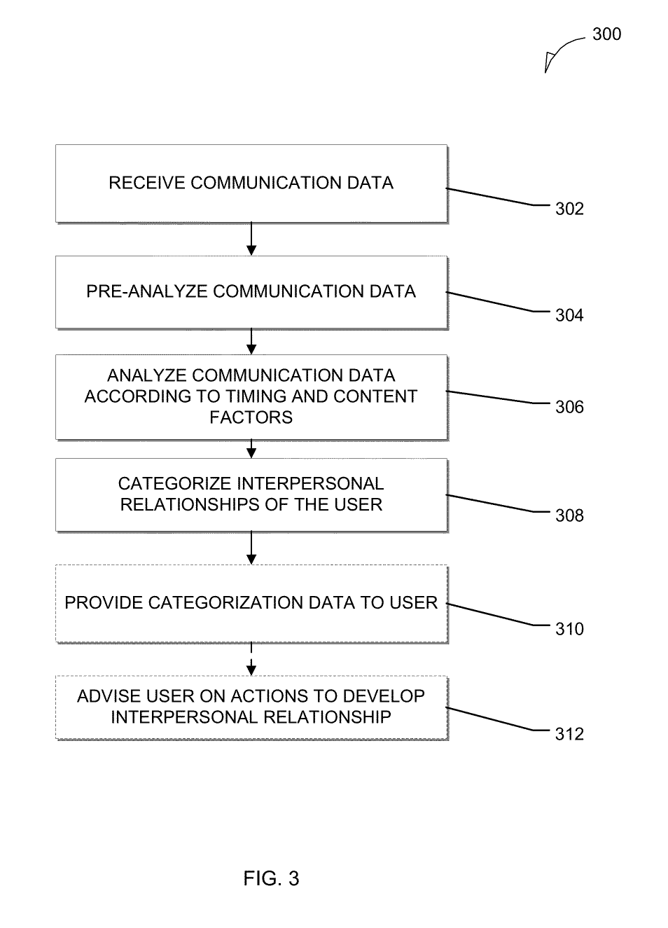

FIG. 3 shows a flow chart of a method 300 for categorizing interpersonal relationships. The method 300 may be performed by processing logic that may comprise hardware (e.g., dedicated logic, programmable logic, and microcode), software (such as computer code executable on a general-purpose computer system or a specifically configured computer system), or a combination of both. In one example embodiment, the processing logic resides at the system 200 illustrated in FIG. 2. The method 300 may be performed by the various modules discussed above with reference to FIG. 2. Each of these modules may comprise processing logic.

As shown in FIG. 3, the method 300 may commence at operation 302, with receiving communication data concerning activities and relationships of the user with one or more contacts of the user in a social networking service. At operation 304, the communication data may be pre-analyzed using a user predefined configuration. Based on the pre-analysis, the communication data may be analyzed according to timing and content factors at operation 306. For analyzing, a section of the communication data related to timing and content factors may be extracted. Information to extract may depend on input type. For example, from a textual input date, time, symbols, and key words may be extracted; from a media input (for example, a photo) date, time, GPS location, and tagged persons may be extracted, and so forth.

The factors may consider, for example, how often the user communicates with a contact, whether it happens on holidays or not, at what time of a day communication occurs, what is the content of the communication, and so forth. The pre-analysis may provide for analyzing information on past communications and on user settings for the contact. For example, the user may specify in the user predefined configuration that the contact is a coworker of the user. Then, a corresponding value may be assigned to the communication data and the value may be included in the calculation of an interpersonal relationship value.

At operation 308, interpersonal relationship of the user and the contact may be categorized using the interpersonal relationship value calculated during the analysis. Each category may be associated with a value range. Based on the interpersonal relationship value, the contact may be assigned to the category with the value range that includes the calculated value.

The categorization data may be provided to the user via a graphical output interface at optional operation 310. The categorization data may be represented to the user graphically as concentric circles with the user in the central circle and his contacts in other circles located according to how close are interpersonal relationship of the user and the contact.

At optional operation 312, the system may advise user on actions to develop, improve, or enhance his relationship with a contact. For example, the system may advise the user to respond to posts of the contact, evaluate posts of the user, and so forth.

The categorization data may be used to selectively provide activity of the contacts to the user and otherwise. For example, the user may specify a circle that may have access to specific posts or information of the user. Additionally, the user may receive notifications about all activity of the contacts from the closest circle and only some notifications about activity of the contacts from more distant circles.

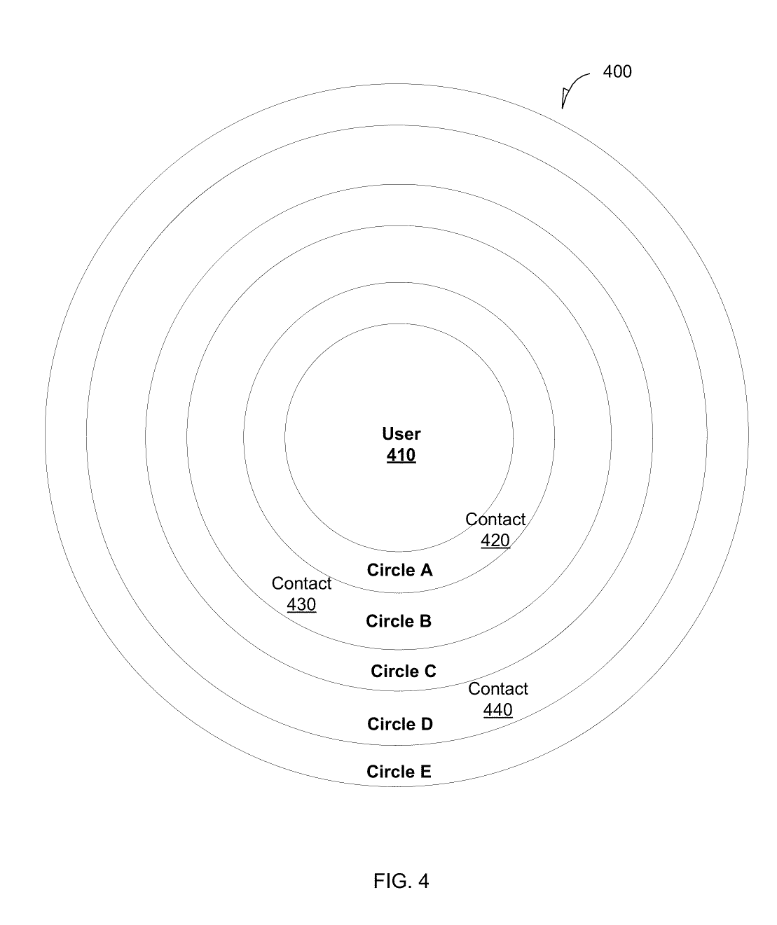

FIG. 4 shows an example graphic representation 400 of categorized user relationships. The results of user interpersonal relationships categorizing may be presented in the form of a number of concentric circles wherein the central circle represents the user 410 and the circles A-E around the central circle represent his contacts 420-440 according to the kind of relationships between this user 410 and the contacts 420-440. The closer and more positive are the relationships with a contact, the closer is the position of the contact to the central circle.

For example, circle A may represent user relationships with his family and close friends or his romantic relationships. A contact 420 positioned in circle A may be spouse or a child of the user 410. Accordingly, circle B may represent another positive stage of relationships—former classmates of the user 410 or his fellow-workers and so forth. Thus, a contact 430 may be a classmate of the user 410. Next, circle C may represent acquaintances or relationships with minimal effect on the user 410. For example, circle C may represent user relationships with his colleagues or associates. Circle D may represent relationships, which the user 410 has to maintain, but wants to minimize their effect on his life. That may mean relationships with some negative tint. A contact 440 may represent one of such relationships. And finally, circle E may represent negative relationships with some particular users.

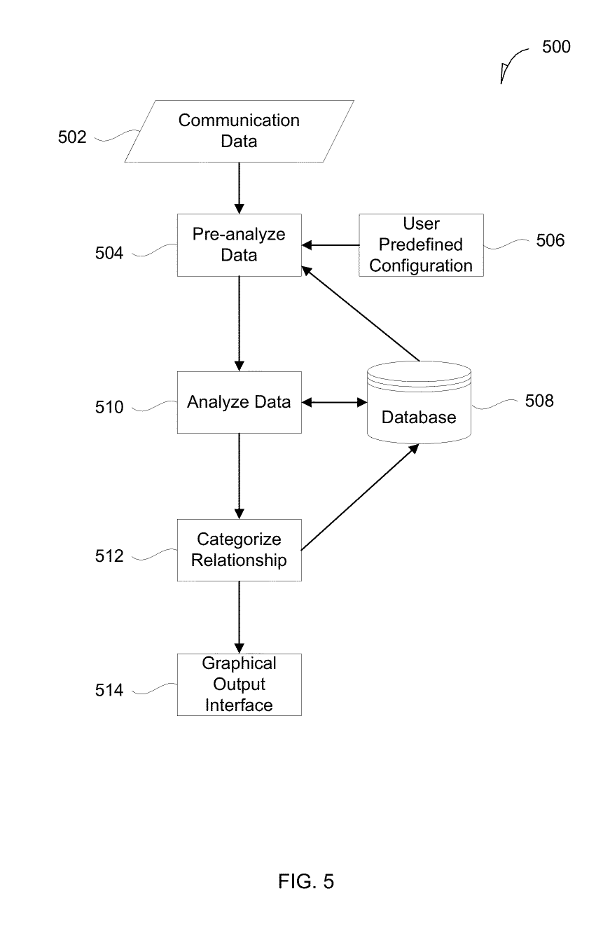

FIG. 5 is a flow chart representing categorizing 500 of interpersonal relationships of a user in a social networking service using a system for automatic categorizing of interpersonal relationships. The categorizing may start with receiving communication data 502 associated with a user profile in the social networking service. The communication data may include creating a new public or private post in a social networking service (including text, event, picture, video posts, and so forth), updating an existing self-post (editing of previous posts), responding to an existing private or public post (including reply to a message, comments and media responses and responding to an event), interacting with social networking communication software (for example, Like button, +1 button, Voting buttons or similar software where user can express that he likes or supports certain content on social networking services). Various types of data may be associated with various values.

The communication data 502 may be pre-analyzed 504 using a user predefined configuration 506. The user predefined configuration 506 may store user settings related to interpersonal relationship with one or more contacts. By specifying user settings in the user predefined configuration 506, the user may supervise and administer automatic categorization of his interpersonal relationship in the social networking service.

Pre-analyzing may include checking for user settings related to the communication data. For example, the communication data may include a new post of a contact named John published in the user timeline. During the pre-analyzing, the system may check whether any settings related to John exist in the user predefined configuration 506. John may be marked by the user as a classmate, so the value of the post may be adjusted correspondingly.

Then, a database 508 may be checked for any data related to previous relationship analyses associated to John. If such data is found, it may also be considered when the communication data is analyzed 510.

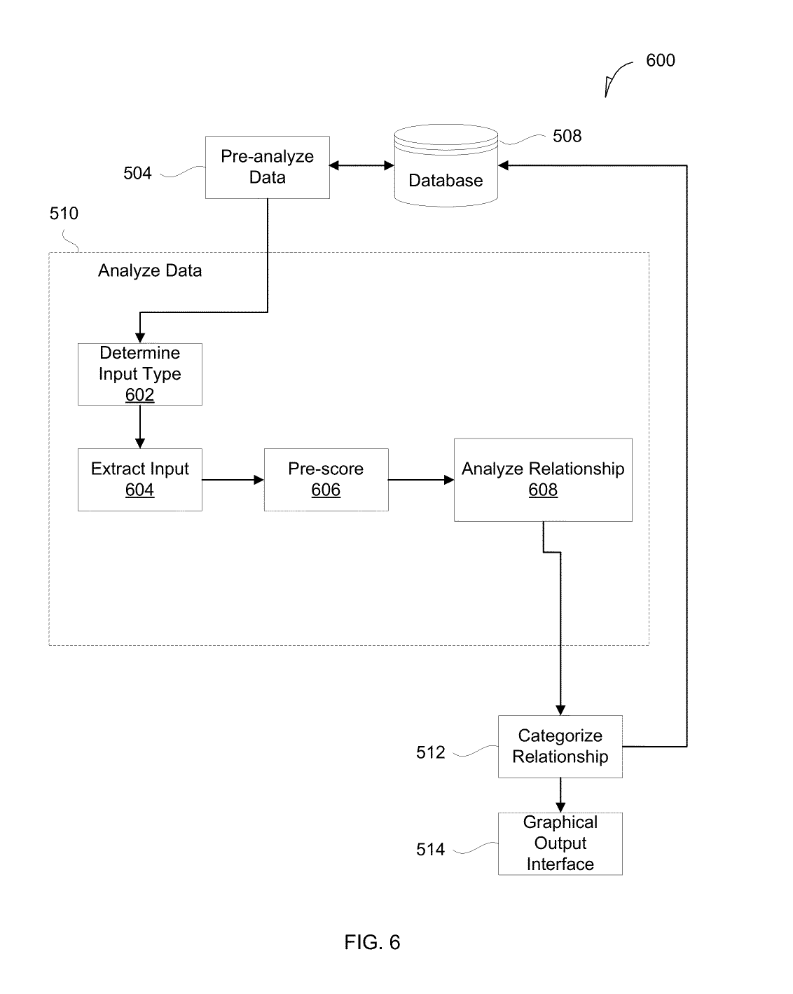

The communication data may be analyzed 510 based on timing and content factors and considering the value adjusted during the pre-analyzing process and data on previous relationship analyses. In more detail, the analyzing process is described with reference to FIG. 6.

During the communication data analysis, an interpersonal relationship value may be calculated. This value may be used to categorize relationship 512 with the contact. The categories (for example, circles A-E at FIG. 4) may be associated with a value range. The contact with a value with a value range of a certain category may be assigned to this category.

The categorization data may be presented to the user via a graphical output interface 514. The graphical output interface 514 may show the result of interpersonal relationship categorization in a simple and understandable graphical format. The graphical output interface 514 may have a main interface on which the user may see all relationships with his contacts in an overview page (for example, FIG. 4). Additionally, the user may have an option to receive detail information about relationships with his contacts to understand the current stage and the trend of his relationship with his contacts. In some embodiments, the system may advise the user on actions to improve, develop, or limit his relationship specific contacts in the social networking service.

FIG. 6 represents detailed analyzing of communication data of a user of a social networking service via a system for automatic categorizing of interpersonal relationships. After pre-analyzing 504 the communication data according to a user predefined configuration and data from the database 508, the communication data may be analyzed 510.

The analyzing 510 may include determining of an input type 602 of the data. In some example embodiments, the data may be divided into 4 input types:
Type 1: Textual Data including (NEW PUBLIC TEXT) (NEW PRIVATE TEXT) (NEW COMMENT-REPLY) (UPDATED PUBLIC TEXT) (UPDATED PRIVATE TEXT) (UPDATED COMMENT-REPLY);
Type 2: Media Input Including (NEW PHOTO POST) (NEW VIDEO POST) (NEW AUDIO POST) (REPLY PHOTO POST) (REPLY VIDEO POST) (REPLY AUDIO POST);
Type 3: Communication Software Interaction including (LIKE) (SHARE) (+1) (VOTING)
Type 4: Events including (NEW EVENTS) (UPDATED EVENTS) (RESPOND TO EVENTS)

When the input type of the communication data is determined, the input may be extracted 604. For this purpose, a section of the communication data related to timing and content factors may be extracted for scoring and analyzing. For example, information to extract from a textual input may include date, time, symbols, and key words. Information to extract from a media input (for example, a photo) may include date, time, GPS location, tagged persons, as well as any other key information attached to the photo. The extracted information may be passed for pre-scoring 606.

The pre-scoring 606 may assign a score of the communication data without analyzing its content. For example, the value (+0.01) may be assigned to a reply message to the original post, the value (+4.0) may be assigned to a new activity event, and so on. When a pre-score is assigned, the communication data and the assigned pre-scores may be used to analyze relationship 608.

During the analysis, an interpersonal relationship value may be calculated and the effect of the communication data on the relationship between the user and the contact associated with the communication data may be determined. After that, the interpersonal relationship value for the communication data may be used for categorizing relationship 512. To categorize interpersonal relationship of the user and the contact, the interpersonal relationship value may be evaluated in combination with previous interpersonal relationship values. Based on the evaluation, the contact may be assigned a category of interpersonal relationship.

The categories may include, for example, relationships with close friends, romantic relationships and close relatives; relationship with positive effect on the user (i.e., educational relationships); natural relationships with minimum effect on the user; negative relationships; and unfriends.

In some example embodiments, the user may represent a commercial product. In this case, the categories may be different. For example, the categories may be as follows: positive feedbacks on relations with the product; informational relations with the product; negative relations with the product.

The assigned category may be provided to the user via the graphical output interface 514 and/or saved to the database 508. Additionally, the graphical output interface 514 may present a trend of interpersonal relationship of the user and the contact and calculate future relationship stages of the user with the contact.

In some embodiments, weakness or strength, a trend or anticipated direction of a relationship with a contact may be determined. Based on such determination, suggestions on how to improve the relationship may be provided to the user. The suggestions (advice) may be provided to the user via the graphical output interface 514.

According to some example embodiments, automatic categorizing of interpersonal relationship may be illustrated by the following practical example.

The system for automatic categorizing of interpersonal relationship may receive communication data related to user. The communication data may come from Facebook and comprise a new post on a wall of the user. The input type may be an activity event, since the user may plan an activity with Fabian, Pascal, and Alexandra. The value for an outdoor activity (+4.0) may be determined, and relationships of the user with Fabian, Pascal and Alexandra may be updated correspondingly in the database.

Additionally, the post may receive 13 LIKES from 13 contacts. The value of LIKE Button (+0.5) may be determined and relationship between the user and 13 contacts may be updated correspondingly.

After that, a textual reply to the original post may be received from a contact Caroline. The reply may be analyzed for the content. The analysis may determine that the contact agrees with the user and gives more information about the activity. The system may calculate the value for this response as follows: reply to message (0.01+), agree with user on a topic (0.1+), provide more information on the discussed topic (0.05+). The system may update the relationship between the user and Caroline based on the mentioned values.

Thus, interpersonal relationship of the user with his contacts in a social networking service may be automatically categorized with minimum assistance of the user. Based on the categorization, access of some categories of the contacts to user activity may be limited and vice versa.

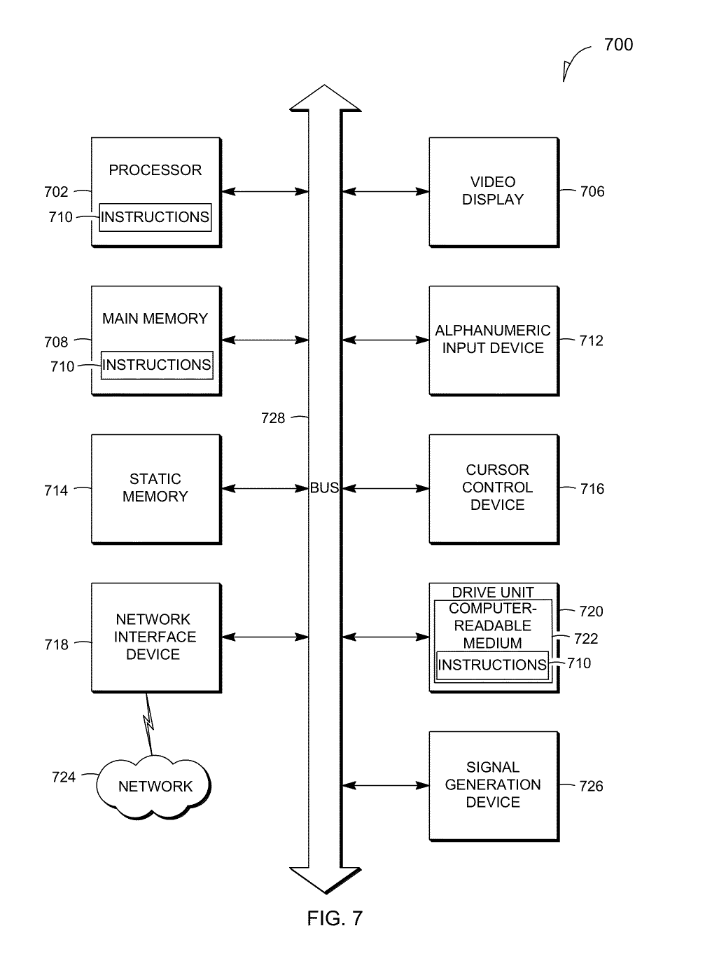

FIG. 7 is a diagrammatic representation of an example machine 700 in the form of a computer system within which a set of instructions for causing the machine to perform any one or more of the methodologies discussed herein is executed. In various example embodiments, the machine operates as a standalone device or may be connected (e.g., networked) to other machines. The machine may include its own internal database or be connected to an external database in order to provide substantially real time updates. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 700 includes a processor or multiple processors 702 (e.g., a central processing unit (CPU), a graphics processing unit (GPU), or both), a main memory 708, and a static memory 714, which communicate with each other via a bus 728. The computer system 700 may further include a video display unit 706 (e.g., a liquid crystal display (LCD)). The computer system 700 may also include an alphanumeric input device 712 (e.g., a keyboard), a cursor control device 716 (e.g., a mouse), a voice recognition or biometric verification unit (not shown), a disk drive unit 720, a signal generation device 726 (e.g., a speaker), and a network interface device 718. The machine 700 may further include a data encryption module (not shown) to encrypt data.

The disk drive unit 720 includes a computer-readable medium 722 on which is stored one or more sets of instructions and data structures (e.g., instructions 710) embodying or utilizing any one or more of the methodologies or functions described herein. The instructions 710 may also reside, completely or at least partially, within the main memory 708 and/or within the processors 702 during execution thereof by the machine 700. The main memory 708 and the processors 702 may also constitute machine-readable media.

The instructions 710 may further be transmitted or received over a network 724 via the network interface device 718 utilizing any one of a number of well-known transfer protocols (e.g., Hyper Text Transfer Protocol (HTTP)).

While the computer-readable medium 722 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Thus, a system and method for automatic categorizing of interpersonal relationships of users via a social network have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer-implemented method for automatic categorizing of interpersonal relationships, the method comprising:
receiving communication data of the user and one or more contacts, the communication data being associated with a social networking service;
pre-analyzing the communication data using a user predefined configuration;
analyzing, based on the pre-analyzing, the communication data according to timing and content factors, wherein the analyzing includes extracting a section of the communication data related to the timing and content factors;
categorizing, based on the analyzing, the interpersonal relationships of the user and the one or more contacts.

2. The method of claim 1, further comprising providing, via a graphical output interface, data of the categorizing to the user, the graphical output interface communicating with the social networking service.

3. The method of claim 1, further comprising storing data of the pre-analyzing, analyzing, and categorizing to a database.

4. The method of claim 1, wherein the timing and content factors include a frequency, a date, a time, an intensity, and content of communication of the user and the one or more contacts.

5. The method of claim 1, wherein the categorizing is performed automatically.

6. The method of claim 1, further comprising advising the user on actions to develop the interpersonal relationships with the one or more contacts.

7. The method of claim 1, further comprising determining a trend of the interpersonal relationships of the user with the one or more contacts, the trend being provided to the user via a graphical output interface.

8. The method of claim 1, further comprising integrating with the social networking service.

9. The method of claim 1, wherein the social networking service includes a social networking website, a microblog, a blog, a chat, and a forum.

10. The method of claim 1, further comprising selectively providing activity of the one or more contacts to the user based on the categorization.

11. The method of claim 1, further comprising selectively providing activity of the user to the one or more contacts based on the categorization.

12. A system for categorizing interpersonal relationships, the system comprising:
a processor configured to:
receive communication data of the user and one or more contacts, the communication data being associated with a social networking service;
pre-analyze the communication data using a user predefined configuration;
analyze, based on the pre-analyzing, the communication data according to timing and content factors, wherein the analyzing includes extracting a section of the communication data related to the timing and content factors;
categorize, based on the analyzing, the interpersonal relationships of the user and the one or more contacts;
a database configured to store data of the pre-analyzing, analyzing, and categorizing;
a graphical output interface configured to provide data of the categorizing to the user.

13. The system of claim 12, wherein the communication data include textual data, media data, communication software interaction, and events.

14. The system of claim 12, wherein the user is a commercial product.

15. The system of claim 12, wherein the processor is further configured to integrate with the social networking service.

16. The system of claim 12, wherein the processor is further configured to determine a trend of the interpersonal relationships of the user with the one or more contacts, the trend being provided to the user via a graphical output interface.

17. The system of claim 12, wherein the communication data includes adding a new post in the social networking service, updating of an existing post in the networking service, responding to the existing post, reacting to the existing post, evaluating the existing post, and sharing the existing post.

18. The system of claim 12, wherein the predefined configuration includes user settings to supervise and customize the categorizing.

19. The system of claim 12, wherein the data of the categorizing is represented in a form of one or more circles.

20. A machine-readable medium comprising instructions which, when executed, perform the following operations:
receive communication data of a user and one or more contacts, the communication data being associated with a social networking service;
pre-analyze the communication data using a user predefined configuration;
analyze, based on the pre-analyzing, the communication data according to timing and content factors, wherein the analyzing includes extracting a section of the communication data related to the timing and content factors;
categorize, based on the analyzing, interpersonal relationships of the user and the one or more contacts;
store data of the pre-analyzing, analyzing, and categorizing to a database;
provide data of the categorizing to the user via a graphical output interface.
